(19) United States
(12) Patent Application Publication
(10) Pub. No.: US 2002/0017273 A1
(43) Pub. Date: Feb. 14, 2002

(54) Assembly for providing an engine brake system for an internal combustion engine, in particular of an industrial vehicle, and an internal combustion engine provided with this assembly

(76) Inventors: Giancarlo Dellora, Settimo Torinese (IT); Carlo Prola, Avigliana (IT)

Correspondence Address: ZITO TLP, 26005 RIDGE ROAD, SUITE 203, DAMASCUS, MD, 20872, US

(21) Appl. No.: 09/835,957

(22) Filed: Apr. 16, 2001

(30) Foreign Application Priority Data
Apr. 18, 2000 (IT) T02000A000365

(51) Int. Cl. F02D 13/04

(52) U.S. Cl. 123/321

(57) ABSTRACT

An assembly for providing an engine brake system for an internal combustion engine, in particular of an industrial vehicle, which engine comprises a plurality of cylinders, a cylinder head provided, for each such cylinder, with at least one exhaust valve and, for each such exhaust valve, with a relative control cam having a profile comprising at least one section that can be selectively actuated by varying the valve play, the assembly comprising, for each cylinder, a support body adapted to be connected to the cylinder head and bearing at least one rocker arm support spindle, the rocker arm support spindle being coupled, by means of an eccentric bushing, to a rocker arm adapted to be interposed between an exhaust valve and a cam in order to oscillate about an axis, the assembly lastly comprising an actuator adapted to rotate the eccentric bushing with respect to the support body in order to displace the axis of oscillation of the rocker arms and to vary the valve play between these rocker arms and the exhaust valves.

The present invention relates to an assembly providing an engine brake system for an internal combustion engine, in particular for an internal combustion engine of Diesel type of an industrial vehicle, and comprising a cam distribution shaft and, for each cylinder of the engine, a relative rocker arm for controlling the lift of the exhaust valves of this cylinder.

### BACKGROUND OF THE INVENTION

It is known from U.S. Pat. No. 5,335,636 to control the rocker arms associated with the exhaust by means of cams having sections of profile that can be selectively actuated by varying the valve play and, in particular, a first section of zero lift (i.e. defined by a portion of the base circle of the cam), corresponding substantially to the majority of the intake phase of the relative cylinder, a second section of small constant lift, extending over an angular amplitude corresponding to the final part of the intake phase and to the phases of compression and expansion and a third convex lobe section, corresponding substantially to the exhaust phase and defining an exhaust valve lift law of conventional type.

These known engines are provided with an engine brake device comprising, for each rocker arm associated with the exhaust, an eccentric bushing interposed between the rocker arm and a relative support pin connected directly to the cylinder head of the engine. The bushing in particular has a cylindrical outer surface on which the rocker arm is mounted in an oscillating manner, and an eccentric through axial hole engaged by the support pin. The engine brake device further comprises, for each cylinder, a hydraulic actuator obtained directly in the cylinder head of the engine and controlled by an electronic control unit in order to rotate the eccentric bushing about the axis of the support pin during the phases of actuation of the engine brake. Following this rotation, the axis of oscillation of the rocker arm is displaced, reducing the play present between this rocker arm and the relative exhaust valves so as to provide an exhaust valve lift that is not zero and is defined by the second section of the cams, during the final part of the intake phase and the phases of compression and expansion, in order to dissipate the compression energy that is generated within the relative cylinder.

In known internal combustion engines, the engine brake device of the type described above is integrated into the cylinder head of the engine, thereby substantially conditioning its design and manufacture; the engine brake device is therefore dedicated to a particular type of engine and has to be completely re-designed from time to time. Moreover, the use of the engine brake in existing engines that do not contain it is largely impossible without a compete re-design of the cylinder head.

### SUMMARY OF THE INVENTION

The object of the present invention is to provide an assembly for providing an engine brake system for an internal combustion engine, in particular of an industrial vehicle, which makes it possible simply and economically to resolve the above-mentioned problems.

The present invention therefore relates to an assembly for providing an engine brake system for an internal combustion engine, in particular of an industrial vehicle, which engine comprises a plurality of cylinders, a cylinder head provided, for each such cylinder, with at least one exhaust valve and, for each such exhaust valve, with a relative control cam having a profile comprising at least one section that can be selectively actuated by varying the valve play, characterised in that it comprises, for each cylinder, a support body adapted to be connected to the cylinder head, at least one rocker arm support spindle borne by the support body, an eccentric bushing, a rocker arm adapted to be interposed between an exhaust valve and a control cam and that can be coupled to the rocker arm support spindle by means of the eccentric bushing in order to oscillate about an axis and actuator means adapted to rotate the eccentric bushing with respect to the support body about the rocker arm support spindle in order to displace the axis of oscillation of the rocker arms and to vary the valve play between these rocker arms and the exhaust valves.

The present invention also relates to an internal combustion engine, in particular of an industrial vehicle.

The invention therefore relates to an internal combustion engine, in particular of an industrial vehicle, comprising a plurality of cylinders, a cylinder head provided, for each such cylinder, with at least one exhaust valve and, for each such exhaust valve, with a relative control cam having a profile comprising at least one section that can be selectively actuated by varying the valve play, and, for each cylinder, an eccentric bushing and a rocker arm interposed between the exhaust valve and a control cam and coupled to a rocker arm support spindle by means of the eccentric bushing in order to oscillate about a relative axis and actuator means adapted to rotate the eccentric bushing with respect to the cylinder head about the rocker arm support spindle in order to displace the axis of oscillation of the rocker arms and to vary the valve play between these rocker arms and the exhaust valves, characterised in that it comprises a support body for the rocker arm support spindles coupled to the cylinder head.

### BRIEF DESCRIPTION OF THE DRAWINGS

The invention will now be described with reference to the accompanying drawings, which show a non-limiting embodiment thereof, and in which:

FIG. 1 is an exploded and perspective view of a preferred embodiment of the assembly for providing an engine brake system for an internal combustion engine of the present invention;

FIG. 2 is similar to FIG. 1 and shows a variant of the assembly of FIG. 1;

FIG. 3 shows, partly in cross-section, a detail of the assembly of FIGS. 1 and 2;

FIGS. 4 and 5 show, in plan view, the assembly of FIGS. 1 and 2 respectively.

### DETAILED DESCRIPTION OF THE INVENTION

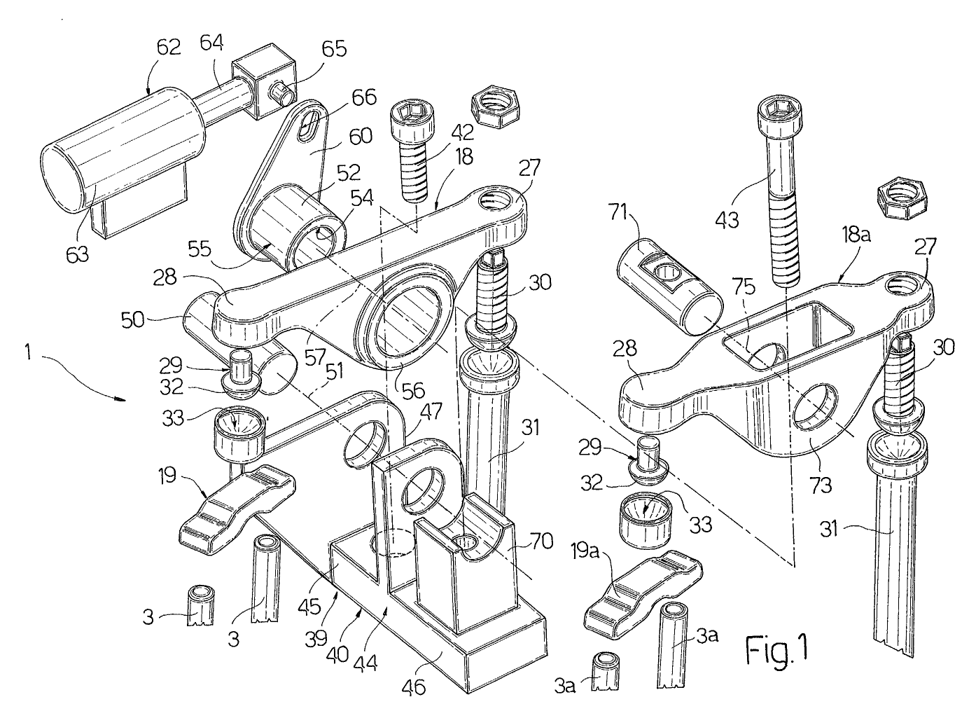

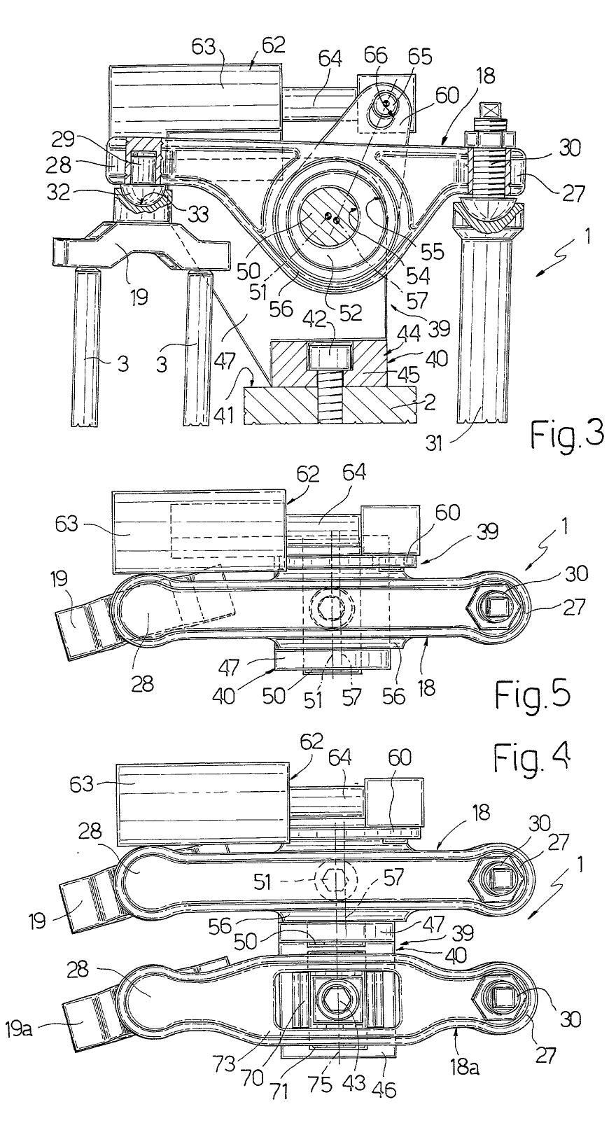

In FIG. 1, an internal combustion engine of an industrial vehicle, advantageously of supercharged Diesel type, is shown overall by 1 and is not shown in detail as it has a structure that is known per se; it comprises a plurality of cylinders and a cylinder head 2 (FIG. 3) provided, for each cylinder, with two exhaust valves 3 and two supply valves 3a (shown in part).

In the accompanying drawings, the parts of the valves 3, 3a of a single cylinder are shown; it will be appreciated that the valves of the other cylinders and the corresponding parts of the engine 1 are completely analogous to those illustrated and/or described below.

Each valve 3, 3a can slide axially in a relative fixed tubular guide (not shown) and is adapted to close a respective exhaust or supply port (not shown) obtained in the cylinder head 2. The exhaust ports communicate with a manifold (not shown) adapted to convey the exhaust gases from all the exhaust ports associated with the cylinders.

The valves 3, 3a are held in the closed position in a known manner by respective springs (not shown); the former are controlled by a rocker arm 18 and the latter by a rocker arm 18a by means of respective crossbars shown by 19 and 19a.

Each of the rocker arms 18, 18a comprises two opposing arms 27 and 28. At one end, the arm 28 bears a member 29 adapted to cooperate with the relative crossbar 19, 19a, while one end of the arm 27 is connected in an adjustable manner (FIG. 3) to a member 30 which is coupled to a cam distribution shaft (not shown) of the engine 1 by means of a relative recall rod 31.

Each member 29 in particular comprises a hemispherical end head 32 facing the relative crossbar 19, 19a and adapted to cooperate with a corresponding hemispherical seat 33 of this crossbar 19, 19a. It should be noted that the term “valve play” used in this description specifies the small empty stroke that the contact member of the rocker arm, in this case the head 32, has to travel to come into contact with the corresponding thrust member of the valves 3, in this case the seat 33 of the crossbar 19, from a zero lift position of the relative cam (or, where specified, from another position).

The cams (not shown) of the distribution shaft adapted to control the exhaust valves 3 have a modified profile of known type comprising sections that can be selectively actuated by varying the valve play. The profile of these cams is in particular formed substantially from a first section of zero lift (i.e. defined by a portion of the base circle of the cam), corresponding substantially to the majority of the intake phase of the relative cylinder, a second section of small constant lift, extending over an angular amplitude corresponding to the final part of the intake phase and to the phases of compression and expansion, and a third convex lobe section corresponding substantially to the exhaust phase and defining a lift law of the valves 3 of conventional type.

The rocker arms 18, 18a form part of an assembly 39 adapted to provide an engine brake system of the engine 1 associated with the above-described profile. In the accompanying drawings, the parts of the assembly 39 relating to the valves 3 of a single cylinder are shown and it will be appreciated that the parts relating to the other cylinders are completely analogous.

In FIGS. 1, 3 and 5, the assembly 39 comprises a connection body 40 separate from the cylinder head 2, disposed in abutment on a surface 41 of the head 2, and rigidly connected to the head 2, in particular by means of a pair of parallel screws 42, 43. The body 40 comprises a base 44 disposed in abutment on the cylinder head 2 and comprising two adjacent portions 45 and 46, of which the portion 45 is engaged by the screw 42 and rigidly bears a fork 47 extending in a projecting manner in order to support the rocker arm 18.

The fork 47 in particular supports a rocker arm support spindle formed by a pin 50, which extends along an axis 51 between the arms of the fork 47 and with which an eccentric bushing 52 is connected. The bushing 52 has an inner cylindrical surface coupled to the pin 50 so as to be able to rotate about the axis 51, and an outer cylindrical surface 55 on which an intermediate portion 56 of the rocker arm 18 is keyed in order to allow this rocker arm 18 to oscillate about an axis 57 parallel and eccentric with respect to the axis 51.

The bushing 52 rigidly bears, at one axial end, a radial lever 60 actuated by an actuator 62 in order to rotate the bushing 52 about the axis 51 with respect to the body 40 and to displace the axis 57 of oscillation of the rocker arm 18. The actuator 62 comprises a cylinder 63 rigidly connected to an arm of the fork 47, for instance by means of screws (not shown) and a stem 64 which projects from the cylinder 63 and can slide with respect to this cylinder 63. The stem 64 is connected at one end to the lever 60 by means of a pin 65 which is parallel to the axis 51 and engages a radial groove obtained at one end of this lever 60.

The portion 46, however, rigidly bears a substantially prismatic member 70, to which a rocker arm support spindle formed by a pin 71 is fixed by means of the screw 43. The rocker arm 18a comprises an intermediate hollow portion 73 which partly houses the member 70 and is hinged on the pin 71 in order to oscillate about an axis 75 parallel to the axes 51 and 57.

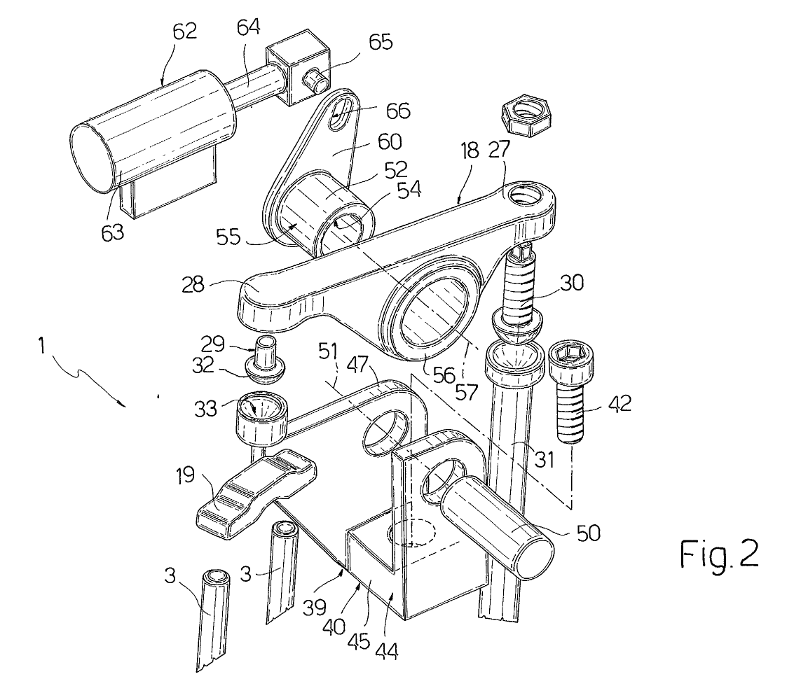

FIGS. 2 and 5 show a variant of the assembly 39, in which the body 40 does not comprise the portion 46 and the member 70 and is secured to the cylinder head 2 by means of the screw 42 alone, while the rocker arm 18a (not shown) associated with the intake valves is mounted in an oscillating manner on a pin borne directly by the cylinder head 2 in a known manner (not shown).

During normal operation of the engine 1, the valve play of the valves 3 is equal to the optimum adjustment value when the second section of the relative cam is active, while there is a substantially greater play when the first section corresponding to the base circle of this cam is active.

When the engine brake is actuated, the axis 57 of oscillation of the rocker arm 18 is lowered by rotating the bushing 52 in order to reduce the valve play of the valves 3 in an almost complete manner, i.e. in order to obtain a residual play equal to the optimum adjustment value when the first section of the distribution cam corresponding to the base circle is active. In this condition, during the final part of the intake phase and during the phases of compression and expansion, the valves 3 remain open by a quantity corresponding to the lift of the second section of the profile of the cams, dissipating the compression energy generated in the cylinder by drawing towards the exhaust manifold.

During the assembly of the engine 1, the assembly 39 makes it possible to provide an engine brake system which is not dependent on a specific type of cylinder head 2.

On the one hand, the base 44 can be readily connected to a cylinder head 2 of substantially any type and structure having a support surface 41 and, on the other hand, the actuator 62 is separate from the head 2, in contrast to known solutions in which it was incorporated in the cylinder head 2. In other words, the provision of the engine brake system described by means of the assembly 29 does not substantially condition the design and manufacture of the cylinder head 2 and therefore the system as described may be applied to engines of different types, whether new or already available, which do not contain it.

It will be appreciated from the above that modifications and variations that do not depart from the scope of protection of the present invention may be made to the assembly 39.

The actuator 62 could in particular be rigidly connected to the cylinder head 2 rather than to the body 40, a single actuator could be provided for all the rocker arms 18 and/or the pins 50 and 71 could be made in one piece and extend along the same axis.

1. An assembly (39) for the provision of an engine brake system for an internal combustion engine (1), in particular of an industrial vehicle, which engine comprises a plurality of cylinders, a cylinder head (2) provided, for each such cylinder, with at least one exhaust valve (3) and, for each such exhaust valve (3), with a relative control cam having a profile comprising at least one section that can be selectively actuated by varying the valve play, characterised in that it comprises for each cylinder, a support body (40) adapted to be connected to the cylinder head (2), at least one rocker arm support spindle (50) borne by the support body, an eccentric bushing (52), a rocker arm (18) adapted to be interposed between an exhaust valve (3) and a control cam and that can be coupled to the rocker arm support spindle (50) by means of the eccentric bushing (52) in order to oscillate about an axis (57) and actuator means (60, 62) adapted to rotate the eccentric bushing (52) with respect to the support body (40) about the rocker arm support spindle (50) in order to displace the axis of oscillation of the rocker arms (18) and to vary the valve play between these rocker arms (18) and the exhaust valves (3).

2. An assembly as claimed in claim 1, characterised in that the actuator means (60, 62) comprise a radial lever (60) rigid with the eccentric bushing (52) and an actuator (62) separate from the cylinder head (2) and comprising a moving member (64) that can be coupled to the lever (60).

3. An assembly as claimed in claim 2, characterised in that the actuator (62) comprises a fixed body (63) that can be coupled to the support body (40).

4. An assembly as claimed in claim 1, characterised in that the support body (40) comprises a support base (44) adapted to be connected to the cylinder head (2) and a fork (47) rigid with the base (44) for supporting at least one relative rocker arm support spindle (50).

5. An assembly as claimed in claim 4, characterised in that the support body (40) comprises a portion (70) rigid with the base (44) for supporting a rocker arm (18a) controlling at least one supply valve (3a).

6. An assembly as claimed in claim 4, characterised in that it comprises at least one screw (43) for fastening the base (44) to the cylinder head (2) and for fastening a rocker arm support spindle (71) to the support body (40).

7. An internal combustion engine (1), in particular of an industrial vehicle, comprising a plurality of cylinders, a cylinder head (2) provided, for each such cylinder, with at least one exhaust valve (3) and, for each such exhaust valve (3), with a relative control cam having a profile comprising at least one section that can be selectively actuated by varying the valve play, and, for each cylinder, an eccentric bushing (52) and a rocker arm (18) interposed between the exhaust valve (3) and a control cam and coupled to a rocker arm support spindle (50) by means of the eccentric bushing (52) in order to oscillate about a relative axis (57), and actuator means (60, 62) adapted to rotate the eccentric bushing (52) with respect to the cylinder head (2) about the rocker arm support spindle (50) in order to displace the axis (57) of oscillation of the rocker arms (18) and to vary the valve play between these rocker arms (18) and the exhaust valves (3), characterised in that it comprises a support body (40) for the rocker arm support spindles (50) coupled to the cylinder head (2).

8. An engine as claimed in claim 7, characterised in that the actuator means (60, 62) comprise a radial lever (60) rigid with the eccentric bushing (52) and an actuator (62) separate from the cylinder head (2) and comprising a moving member (64) that can be coupled to the lever (60).

9. An engine as claimed in claim 8, characterised in that the actuator (62) comprises a fixed body (63) that can be coupled to the support body (40).

10. An engine as claimed in claim 7, characterised in that the support body (39) comprises a support base (44) connected to the cylinder head (2) and a fork (47) rigid with this base (44) for supporting at least one relative rocker arm support spindle (50).

11. An engine as claimed in claim 10, characterised in that the support body (39) comprises a portion (70) rigid with the base (44) supporting a rocker arm (18a) controlling at least one supply valve (3a).

12. An engine as claimed in claim 10, characterised in that it comprises at least one screw (43) for fastening the base (44) to the cylinder head (2) and for fastening a rocker arm support spindle (71) to the support body (40).
